(19) United States
(12) Patent Application Publication
(10) Pub. No.: US 2008/0222381 A1
(43) Pub. Date: Sep. 11, 2008

(54) STORAGE OPTIMIZATION METHOD

(76) Inventor: Gerard Lam, Jersey City, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/970,515

(22) Filed: Jan. 7, 2008

Related U.S. Application Data
(60) Provisional application No. 60/883,679, filed on Jan. 5, 2007.

(51) Int. Cl. G06F 12/06

(52) U.S. Cl. 711/170; 711/E12.084

(57) ABSTRACT

In a system and method for examining the configuration of a storage area network using a browser application, linking to the storage area network using a browser application, obtaining data from a device on the storage area network, parsing the data into records, eliminating redundancies in the records, storing the records in a database, and providing access to the database to a user through the browser.

### CROSS-REFERENCE TO RELATED APPLICATIONS

The present application claims the benefit of U.S. Provisional Application Ser. No. 60/883,679, filed Jan. 5, 2007, which is hereby incorporated by reference in its entirety.

### BACKGROUND OF THE INVENTION

Data storage needs have increased exponentially in recent years due to advances in computing speed and increased reliance on large databases of information. Many businesses need to store immense amounts of data simply to carry out daily functions. In addition, many businesses also require redundancy and system backup capabilities and also create archived copies of their data to ensure that their systems can be restored in the event of a failure in a system or a primary storage failure.

Many businesses add storage to existing networks in the form of additional hosts with attached storage devices. This arrangement creates a risk that if the host fails, the data contained on the attached storage devices may be inaccessible. Other businesses address the need for additional storage by adding storage devices to a network, such as a local area network. Both of these solutions, however, create additional network traffic and thus slow the existing network, especially when large amounts of data must be stored.

One solution to the growing demand for data storage is the creation of storage area networks. A storage area network consists of a plurality of storage devices attached through a network to one or more hosts. The storage area network is connected to the hosts on a separate network from the network connecting the hosts to client computers. This structure solves the problem of storage devices creating traffic that interferes with a client computer's ability to communicate with hosts.

On a storage area network, no single host is connected to any single storage device. Instead, each host can connect to a plurality of storage devices and the storage devices are interconnected.

Although storage area networks provide a solution to network storage concerns, they present serious concerns of their own. Because multiple storage devices are interconnected, data files are often stored in blocks across many different storage devices. If one device fails, it becomes difficult or impossible to reconstruct the stored data. Because of the enormous size of the storage available on storage area networks, it is difficult to track which hosts are utilizing which storage devices, particularly if any device on the network fails and it is a very difficult and complex task to manage the storage area network and efficiently allocate resources.

Thus, there is a need for advanced methods for managing storage area networks and to track and manage stored data on storage area networks in order to more closely and efficiently identify and manage how network devices are interrelated, evaluate infrastructure needs and optimize resources and resource utilization.

### SUMMARY OF THE INVENTION

The present invention is a method and system for identifying, examining, presenting, reporting, correlating, evaluating, managing, controlling and correcting the configuration of a storage area network (SAN). The system obtains information, such as, for example, by querying, grabbing, downloading or being provided with information, relating to a storage area network, which includes configuration data detailing the infrastructure of, such as, for example, various devices in the storage area network and how they are related and interconnected. The system parses the data into relevant blocks, such as, for example, records, eliminates redundancies in the records, and maps the data, such as, for example, by creating links between the records using information, such as, for example, the device identification numbers or world wide names, corresponding or relating to the devices in the network. The records are then added to a database which may be presented to a user in the form a graphical user interface (GUI). The user may access different portions of the infrastructure, such as, for example, using the GUI to provide views into the database. These views could include a variety of views, such as, for example, a host view which shows details for any host attached to the SAN, a switch view, a zone view, a storage array view, a storage device view, a business view, an application view, a fabric view, and other views. When information concerning a particular device comprising the infrastructure is shown, the system may also provide a view of the connections that the device shares with other devices on the SAN. A user may also create custom views in order to view information.

An embodiment of the system detects additional information about the infrastructure, including information, such as, for example, regarding configuration errors of the devices. The system may display such information regarding configuration errors that are detected or may transmit such information to other systems or applications or a storage location for auditing purposes. For example, errors may be displayed on a GUI and shown as visual indications when the database is viewed, the system may generate and send reports when errors are detected, or the system may send flags or notices to other systems or applications.

An embodiment of the system may also be used to correct configuration errors. In this embodiment, the system may reconfigure data, data paths, and/or device settings in order to correct errors such as device failures or connection failures. The system may also provide recommendations for the user to correct the errors themselves. Thus, if a particular device or access to a particular device on the SAN malfunctions, the system may evaluate all of the data and paths assigned to that device and possibly re-route future storage and retrieval, or reclassify or rename devices or data paths so that the SAN will continue to function properly and according to routing requirement and/or the system design. In another embodiment, the system may notify a user of a configuration error and provide suggestions as to how to modify the SAN to remedy the configuration error.

In one embodiment the present invention is a method for examining the configuration of a storage area network using a browser application, comprising linking to a portion of the storage area network using the browser application wherein the browser application links to the portion of the storage area network at least one of directly or through a switch, obtaining data from one or more devices comprising a portion of the storage area network that defines one or more parameters about the one or more devices, parsing the data from each of the one or more devices into one or more records, eliminating redundancies in the one or more records, adding the one or more records into a database in a predetermined format, and providing a user access to the records in the database through a first graphical user interface generated by the browser application wherein the first graphical user interface provides for linking to a second graphical user interface that provides access to the one or more records from the one or more devices.

In a further embodiment, the one or more parameters includes a worldwide name. In a further embodiment, the one or more parameters includes a logical unit number.

In one embodiment the one or more devices comprises one or more hosts. In one embodiment the or more devices comprises one or more storage arrays. In one embodiment, the one or more records for the one or more hosts comprises data identifying each host bus adapter coupled to the host.

In one embodiment, the one or more records for the one or more hosts further comprise data identifying one or more zones used by the host.

In one embodiment, the data identifying one or more zones used by the one or more hosts indicates which storage arrays are accessed by a host.

In one embodiment the record for the one or more hosts comprises data identifying the amount of storage space allocated to the one or more hosts on one or more storage arrays accessed by the one or more hosts. In a further embodiment the record for the one or more hosts comprises data identifying one or more switches utilized by the one or more zones.

In one embodiment a method according to the present invention further comprises allowing a user to manually add data to the database.

In one embodiment a method according to the present invention further comprises allowing the user to search the database for a particular device connected to the storage area network using a search engine. In one embodiment the search engine is a boolean search engine.

In one embodiment relationships between the one or more devices are depicted on the graphical user interface.

In one embodiment a method according to the present invention presearching for configuration errors in the storage area network.

In one embodiment the user is notified on the graphical user interface if any configuration errors are found.

In one embodiment the present invention comprises a method for evaluating the configuration of a storage area network comprising coupling a browser application to the storage area network, executing one or more commands on the storage area network to obtain device information for one or more devices comprising the storage area network, parsing the device information into one or more device records, eliminating redundancies in the one or more device records, storing the one or more-device records in a database, providing access to a user to the database through a first graphical user interface generated by the browser application wherein the first graphical user interface provides for linking to a second graphical user interface that provides access to the one or more device records.

In one embodiment, the first graphical user interface is viewable in a first portion of a display and a second graphical user interface is viewable in a second portion of the display.

In one embodiment, the browser application is a web browser.

In one embodiment, the browser application is coupled to the storage area network through a control workstation.

In one embodiment, the one or more commands comprise system commands.

In one embodiment, the device information comprises a worldwide name.

In one embodiment, the user is presented with all device information for a particular device when the user selects the link corresponding to a particular device.

In one embodiment, the user is presented with all device information for one or more devices coupled to the particular device when the user selects the link corresponding to the particular device.

In one embodiment, relationships between one or more device records are depicted on the graphical user interface.

In one embodiment, the present invention comprises a software storage medium including a software program which, when executed by a processing arrangement, is configured to examine a storage area network, said software program comprising a first module which, when executed, links to a portion of the storage area network using a browser application wherein the browser application links to the portion of the storage area network at least one of directly or through a switch, a second module which, when executed, obtains data from one or more devices comprising the portion of the storage area network that defines one or more parameters about the one or more devices, a third module which, when executed, parses the data from each of the one or more devices into one or more records, a fourth module which, when executed, eliminates redundancies in the one or more records, a fifth module which, when executed, adds the one or more records into a database in a predetermined format, and a sixth module which, when executed, provides access to the database to a user through a first graphical user interface generated by the browser application wherein the first graphical user interface provides for linking to a second graphical user interface that provides access to one or more records from one or more devices.

In one embodiment, the present invention comprises a system for management of a storage area network comprising means for collecting data from the one or more devices, means for parsing the data into one or more records, means for eliminating redundancies in the one or more records, means for storing the one or more records in a database, means for creating links between the one or more records based on the configuration data, and means for providing a user with access to the database through a graphical user interface. In one embodiment, the links are depicted between the one or more records on the graphical user interface.

### BRIEF DESCRIPTION OF THE FIGURES

FIG. 1 depicts one embodiment of a storage area network.

FIG. 2 depicts a more detailed view of selected components in a storage area network.

FIG. 3 is a flow diagram depicting a method according to the present invention.

FIGS. 4-22 depict various screenshots of SAN evaluation software according to one embodiment of the present invention.

FIG. 23 depicts the relationships between various programming modules according to one embodiment of the present invention.

### DETAILED DESCRIPTION OF THE PREFERRED EMBODIMENTS

The invention will be described with reference to one embodiment of a storage area network. A storage area network (SAN) is a network of hosts connected to storage devices which are adapted to store large amounts of information. One skilled in the art will recognize that the present invention may function on a plurality of configurations of networks. In one embodiment, the present invention is implemented on a Fibre Channel network as described in U.S. Pat. No. 6,845,395 to Blumenau which is hereby incorporated by reference in its entirety.

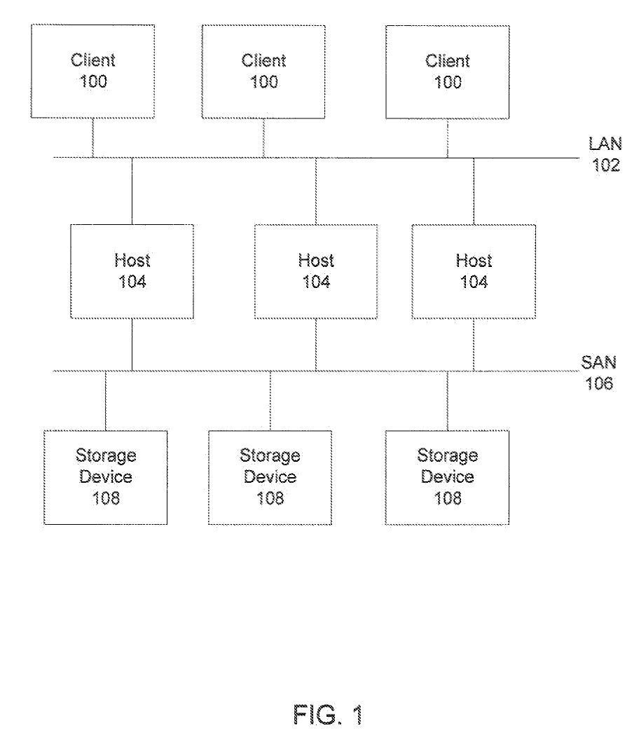

FIG. 1 depicts a simplified embodiment of a storage area network. A plurality of client computers 100 are connected to a network, such as a local area network (LAN) 102 or wide area network (WAN). The client computers communicate through the LAN 102 with a plurality of hosts 104. The hosts then communicate through a storage area network (SAN) 106 with a plurality of storage devices 108. Each host 104 may communicate with any storage device 108 through the SAN. The storage devices 108 may also communicate with each other over the SAN 106. The SAN is unique in that neither the client computers 100 nor the hosts 104 are connected directly to any storage device 108.

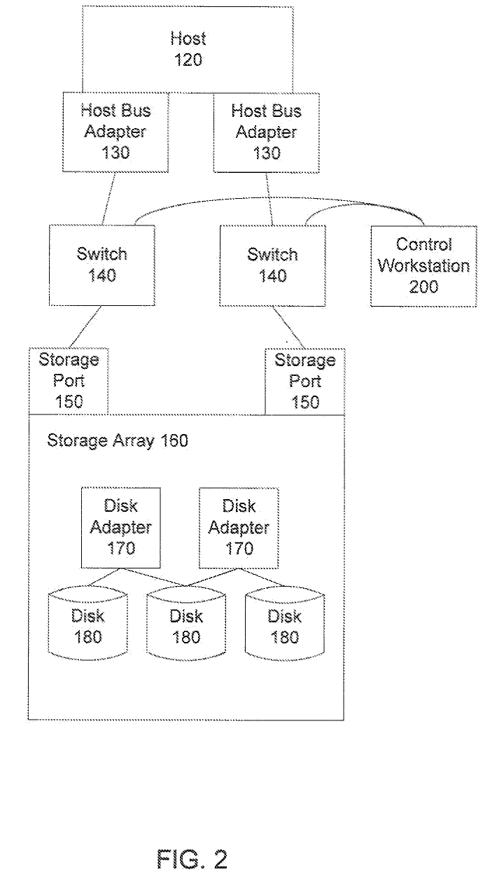

FIG. 2 shows a more detailed embodiment of a SAN. In this embodiment, A SAN 100 has at least one server or host 120. Although only one host is depicted in FIG. 2, one skilled in the art would recognize that a typical SAN includes many hosts. Each host preferably has two host bus adapters (HBAs) 130 which connect the host to the network. Each HBA has a unique number assigned to that HBA called a worldwide name (WWN). The HBA translates data from the host 120 into a format which may be transmitted over a network, such as packet form. When an HBA receives data from the network, the HBA translates the data back into a format readable by the host 120.

The HBA 130 transmits data through a switch 140 which controls communications over the network. A typical SAN includes many switches which may each communicate with a number of hosts. The switches may be grouped into fabrics. The HBA 130 communicates through the switch 140 with a storage port (SP) 150. Each SP 150, like each HBA 130, has a WWN associated with it. The SP 150 is connected to a storage array 160. The SP 150 translates data received from the network into a format useable by the storage array, typically data blocks. The SP also controls access to the storage array 160. The storage array contains a plurality of disks 180 or other storage devices and communicates with these disks 180 through disk adapters 170. Each disk adapter 170 may communicate with a plurality of disks 180. The disks 180 are preferably SCSI drives but may be any type of storage device known in the art.

The SAN may also include a control workstation 200. The control workstation 200 connects to at least one switch 140 in the network and may access the storage arrays 160 through the network. The control workstation 200 maintains information concerning data storage on the network. In particular, the control workstation 200 stores the zones of the network. A zone is a communication path in the SAN that is identified by a zone name and contains the WWN of an HBA on the SAN and the WWN of the storage port that particular HBA communicates with. The control workstation 200 may also contain identifiers or labels of all of the devices attached to the SAN as well as the configuration of the various devices attached to the SAN. When the configuration of the SAN is updated, such as by the addition of new storage devices or new hosts to the SAN, the control workstation 200 is updated.

Data stored in a SAN is typically stored on hypers, which are virtual disks that are typically spread across a plurality of actual physical disks. The hypers are spread across a plurality of physical disks so that data stored in a hyper may be recovered even if one of the physical disks fails. Hypers may be grouped into metas. Each hyper or meta is preferably assigned a logical unit number, or LUN, when presented to a host. Each hyper or meta may be mirrored and/or replicated to provide redundancy in case or failure.

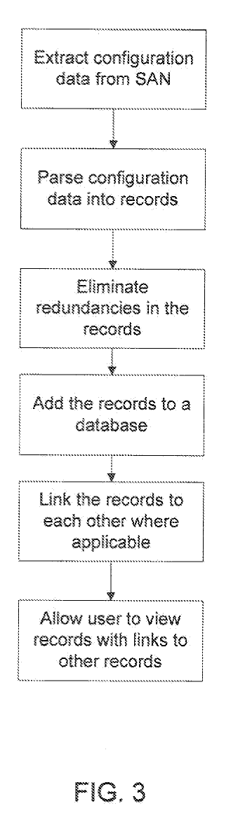

FIG. 3 provides an overview of the process performed by SAN evaluation software according to the present invention. SAN evaluation software is used to query the SAN, extract configuration data from the SAN, parse the data into records, eliminate redundancies in the records, add the records to the database, and provide the database to a user for generating reports and accessing information concerning the configuration of the SAN.

The SAN evaluation software initially obtains data from the SAN concerning the configuration of the SAN. In one embodiment, the SAN evaluation software queries the control workstation 200 attached to the SAN and obtains configuration data detailing the different devices attached to the SAN, their identification strings or numbers, and how they are interconnected. The SAN evaluation software may also obtain a list of zones used on the SAN.

For example, for a particular host, the software will obtain data related to which HBAs are connected to a host and what their WWNs are. The software will also obtain the switches used by the host, the ports used by the host, the zones used by the host, and the storage arrays used by the host. The software may identify these devices using their device IDs, WWNs, or LUNs.

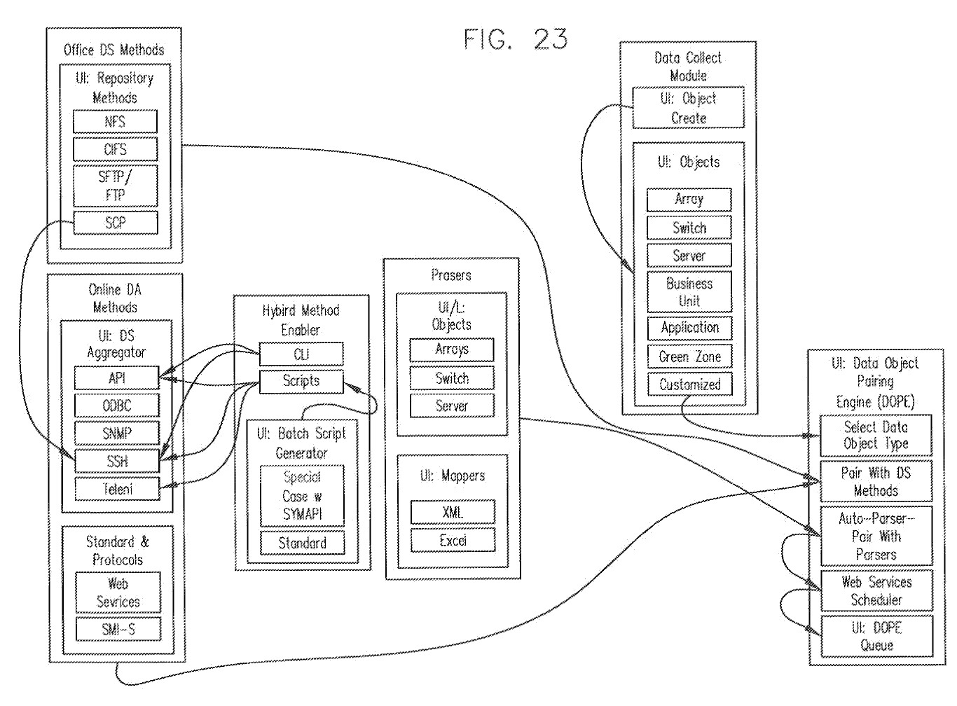

The data collection from the SAN can occur using online or offline methods. The data collection module and various methods of data collection are depicted in FIG. 23. In addition, a hybrid method can be accomplished using native command line interfaces and script association, as well as a built-in tool to dynamically batch script generation.

Once methods are established data objects are created so the data source can be classified. There are no limits to the types of data objects which may created by a user. A data object pairing (DOP) binds the data object to the data source and optionally binds to a parser in order to automatically parse the data to the rules and tables specified in the parser. Data collection in this method captures the process of collecting data in an automated and structured fashion. It forces uniformity and brings about process which otherwise would not exist.

The Data Object Pairing Engine (DOPE) can be auto-executed based on frequency as well as send out emails based on keyword triggers. This is controlled via a Web Service client to run on its own.

In one embodiment, the SAN evaluation software attaches to the SAN and runs a series of commands on the SAN which produce an output, usually in the form of a series of text files, detailing the various devices on the SAN and their interconnections. The commands may be contained in a single program or multiple programs. The commands access the control workstation and may access the other devices attached to the SAN through the control workstation as necessary to obtain the necessary data. The commands may include system commands, such as symdev, as known to those skilled in the art.

The SAN evaluation software may be run on a computer connected to the SAN, such as a host computer, or may be run on a computer remote to the SAN. In some cases, such as when SAN evaluation software is operated by an outside consultant, the SAN evaluation software may not attach to the SAN but may simply provide a SAN administrator with the commands or programs necessary to extract the desired information from the SAN. The administrator may run the commands or programs and then provide the results, usually in the form of text files, to the consultant. Using this process, the SAN administrator never has to provide access to the SAN to the consultant.

The commands may be run as scripts or an executable, such as a PERL script, or in any other programming language that may be used on a device connected to the SAN or in communication with the SAN. In one embodiment, the SAN may have embedded controls such as enabler software used on an EMC network as known in the art or operating system codes available on a particular network. Proprietary software such as the EMC Control Center, available on EMC storage area networks, may also be used to obtain configuration data.

Once the-SAN evaluation software has collected data from the SAN, the software aggregates all of the data and parses data out of the text files or other received format. This module of the software is called the data source aggregator. A database is created and all extracted data is added to the database. The software will recognize the different values attached to the different devices on a network, such as WWNs and LUNs. The software will eliminate redundancies in data when adding the data to the database. The records for the various devices are linked to each other using the network identification numbers for the devices.

The software may start the addition of the data to the database by generating a record for each host serial identification number attached to the SAN. These records may then be populated with other information related to each host, such as the WWN of the HBAs attached to the host. Using the WWN of the HBAs, the zones used by the host may then be linked to the host records. The zones used by the host will indicate which storage arrays are accessed by a particular host. The amount of space allocated to each host on each storage array accessed by the host is also added to the host records. The switches used for each zone may also be added to the host records so that when the various zones are listed for a particular host, the switch used by that zone may be viewed.

At any time after the initial collection and parsing of data concerning the SAN, the user may use the SAN evaluation software to add more information to the database, such as an additional file concerning additional configuration data.

Once the SAN evaluation software has populated a database with configuration information concerning the SAN, the user is presented with an interface which allows the user to view configuration information concerning the SAN in a plurality of different views. In these different views, the devices may appear as hyperlinks so that a user may, at any time, click on a particular device to see all of the details concerning that device.

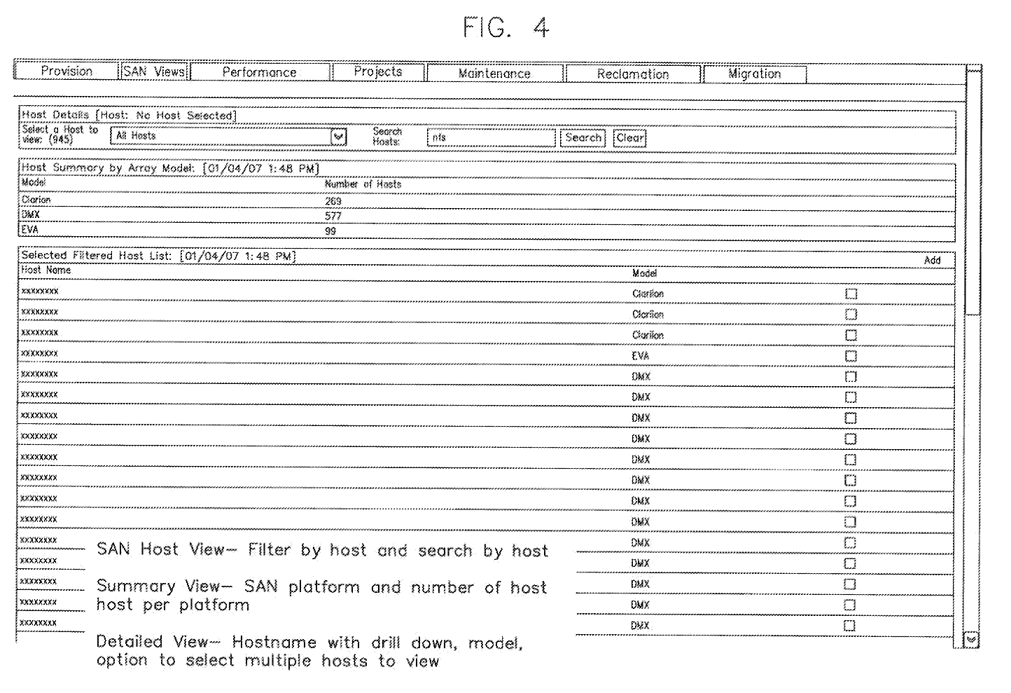

The host summary view depicted in FIG. 4 shows the screen a user is presented with when a user enters the system or when a user clicks a “Host” icon on the main system screen. The host summary view provides the user with a drop-down menu which provides a user with a list of all of the hosts attached to the SAN and allows the user to pick a host. Alternatively, if the user knows the name or part of the name of a host, the user may type the name of the host or a portion of the name of the hose into the search box provided and click “Search.” This view also shows the host summary by array model, which tells the user how many hosts of a particular type are attached to the SAN. This view also depicts a filtered host list which shows a list of hosts as customized by the user.

The view depicted in FIG. 4, as well as the other views, show a collection of tabs on the top of the view which allow the user to view different reports concerning the system. The tabs may be customized by the user to conveniently present views to the user that the user utilizes frequently.

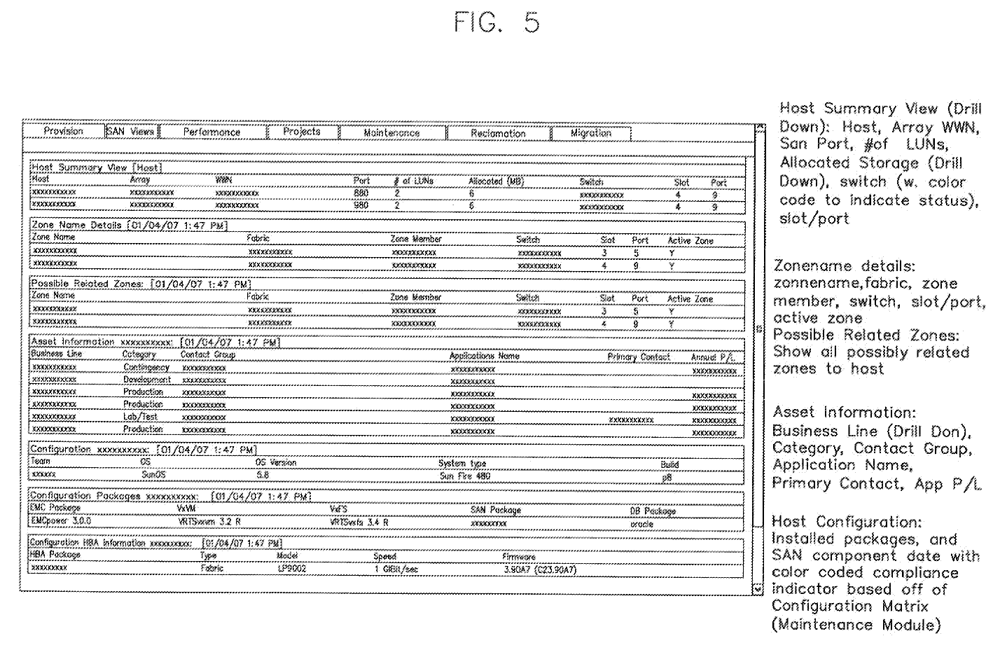

Once a user selects a particular host, the user is presented with the host summary view shown in FIG. 5. The host summary view shows the host name, storage arrays assigned to a particular host, the WWN of HBAs attached to the host, the ports assigned to communicate with the HBAs, the amount of storage assigned to the host, the switch that the host uses to communicate through the network, and the slot and port assigned to the host. This view also shows other information related to the host, such as the zones utilized by the host and the fabrics used by the zones.

The host summary view depicted in FIG. 5 is particularly useful in detecting spanning of a particular host. This occurs when a host is connected to more than one storage array, spanning the storage of that host to two or more arrays. When a host spans two arrays, the arrays will be listed under the host summary view and an error message may be presented to the user. The user may be able to click a “fix” button which will reconfigure future storage by this host to only one array and may even move the storage from the two arrays to only a single array so that the host need only access a single storage array.

The software may be configured to remedy other errors commonly found in a SAN, such as a malfunctioning HBA. Because each host is assigned two HBAs, if the system detects a number of zones assigned to the WWN of a particular HBA but does not detect the HBA on the system, the HBA is malfunctioning. The software may reconfigure all of the zones assigned to the malfunctioning HBA to the other HBA assigned to the host attached to the malfunctioning HBA. In this way, the SAN will continue to function and no data will be lost due to one malfunctioning HBA.

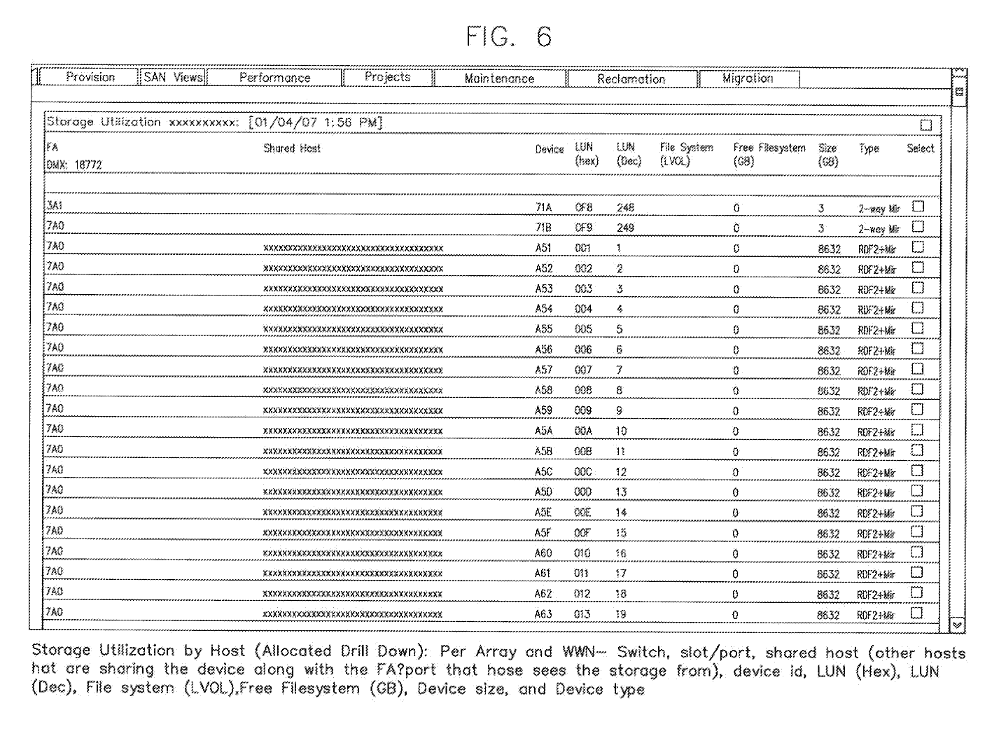

If a user desires to retrieve more particular information concerning the storage assigned to the host, the user may select the storage utilization button on the screen which will provide the user with the storage utilization report shown in FIG. 6. The storage utilization screen shows the various storage ports, called FAs in this embodiment, the hosts connected to the FA, the devices utilized by the FA, the LUN for each hyper utilizes by the FA in both hexadecimal and decimal terms, and the size of the array in both free and assigned space.

If an error is detected when any of these views are presented to the user, a visual or audio indication of the error may be presented to the user to alert the user to the error. For example, if the system detects that a particular zone assigned to a host as shown in FIG. 5 is assigned a WWN for a port that is not present on the system, the record showing the zone may be presented in red or may be accompanied by a red icon which may provide the user with detailed error information if selected.

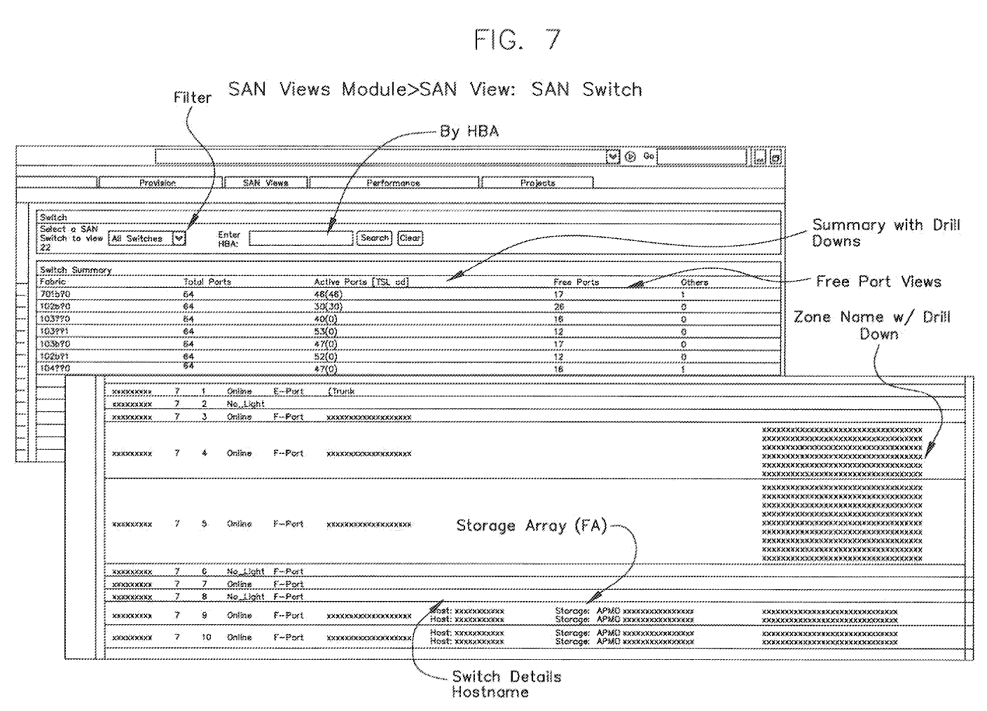

FIG. 7 depicts screens which a user may use to access more information about a particular switch. The user may select a switch button on link on the screen to be presented with a screen that allows the user to select a particular switch from a list provided in a drop-down menu or the user may type the name or a portion of the name of a switch into a text box and click “Search.” The user is also presented with a list of switches connected to a particular SAN by fabric, with the number of ports assigned to each switch provided.

When a user selects a particular switch, the user is provided with details regarding that switch, including the hosts that utilize that switch, the storage arrays that are contacted by that switch, and the zones that utilize that particular switch to communicate:over the SAN.

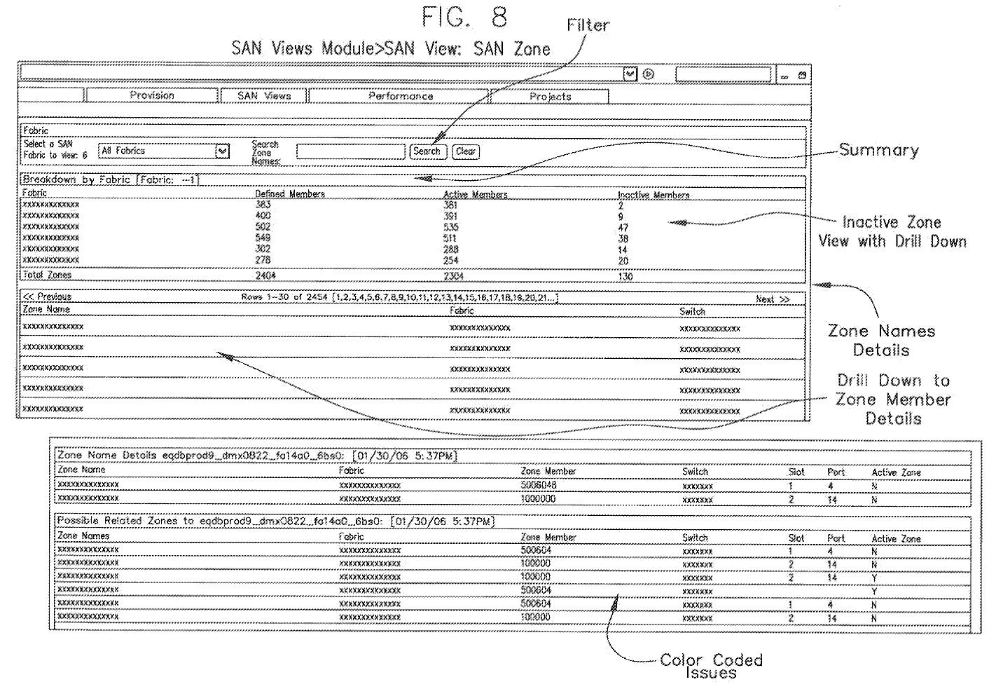

FIG. 8 depicts screens which a user may use to access more information about a particular fabric. The user may select a switch button on link on the screen to be presented with a screen that allows the user to select a particular fabric from a list provided in a drop-down menu or the user may type the name or a portion of the name of a fabric into a text box and click “Search.” A list of fabrics is also presented to the user including devices that utilizes that fabric. When a user selects a particular fabric, the user is presented with zones that utilize that fabric, and the switch within the fabric used by the zones. The user may also be presented with the slot and port utilized by the zone.

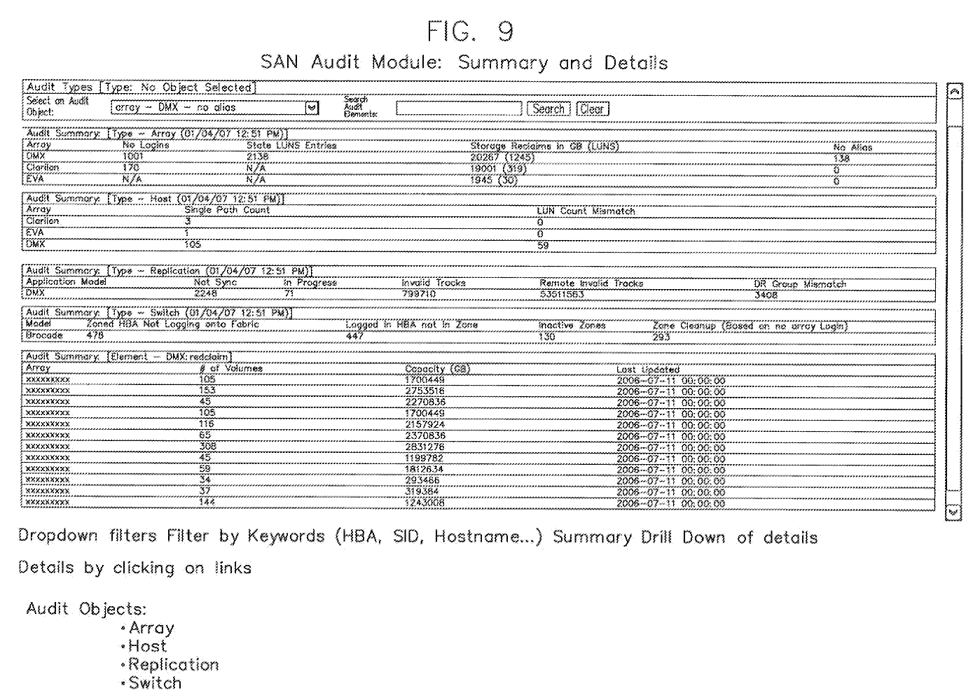

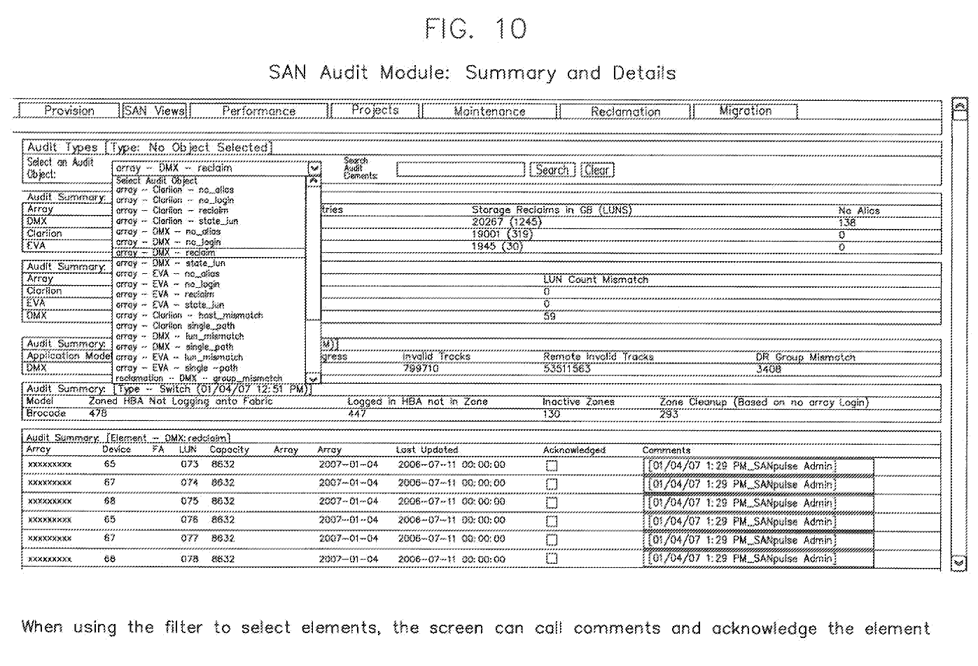

The SAN evaluation software may also be used to perform audits, or detailed evaluations, of any particular device attached to the SAN. Once a user has entered the audit screen, depicted in FIG. 9, the user may select a device to be audited from a drop-down menu or the user may type the name or part of the name in the search box and click “Search.” The audit screen also depicts audit summaries of different types below the search box, such as an audit summary for an array, an audit summary for a host, an audit summary for a replication, an audit summary for a switch, and an audit summary for an element. Another example of an audit summary is depicted in FIG. 10, which shows checkboxes in the audit summary so that a user may acknowledge a particular audit object and the system will capture the user that requested the audit. Comments may also be added to a particular audit in this view.

The SAN evaluation software may also allow the user to create custom views with a tool entitled SAN Block Builder. The custom views may be useful if a particular user has an interest in monitoring one particular area of the SAN or if the user wants to run a particular program or script on one portion of the SAN. For example, a user may create a link on the SAN evaluation software user interface that automatically displays all devices currently on the SAN that are not assigned to any host. Such a link may allow the user to view lost data which affects SAN efficiency.

In one embodiment, the user may load business information related to the configuration of the SAN into the SAN evaluation software database. This business information may include items such as various business units in a company, which hosts are assigned to each business unit, and the cost of any particular storage device. This information may be used to evaluate the hosts and storage devices utilized by particular business units. This information may also be utilized to determine the costs of the SAN that are attributable to any particular business unit so that each business unit may pay a portion of the cost of the SAN that is utilized by that unit. This is called a “chargeback” calculation.

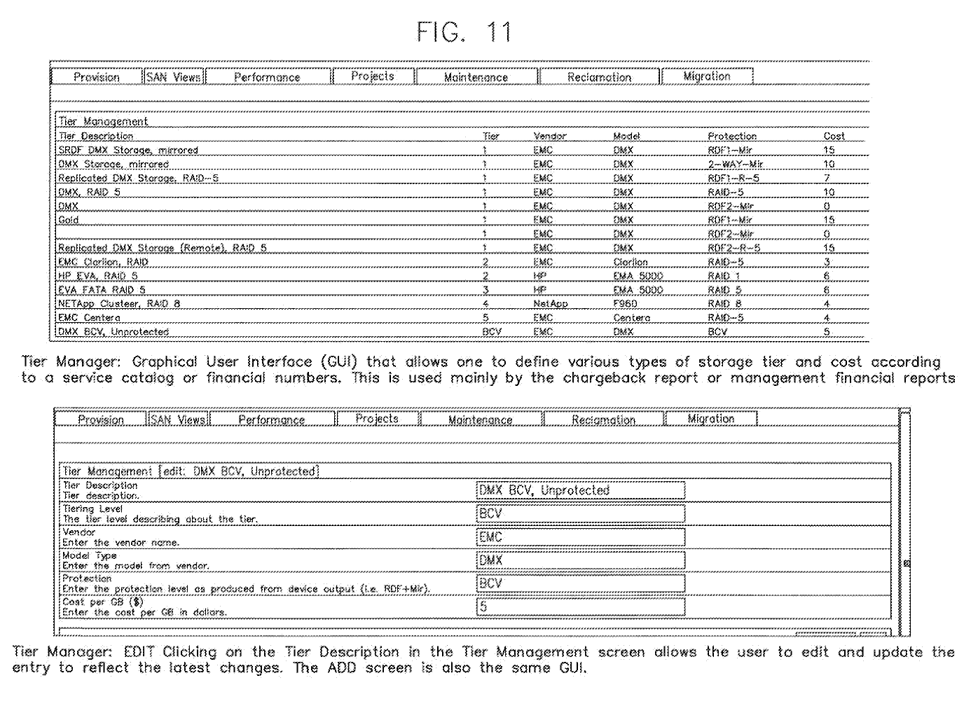

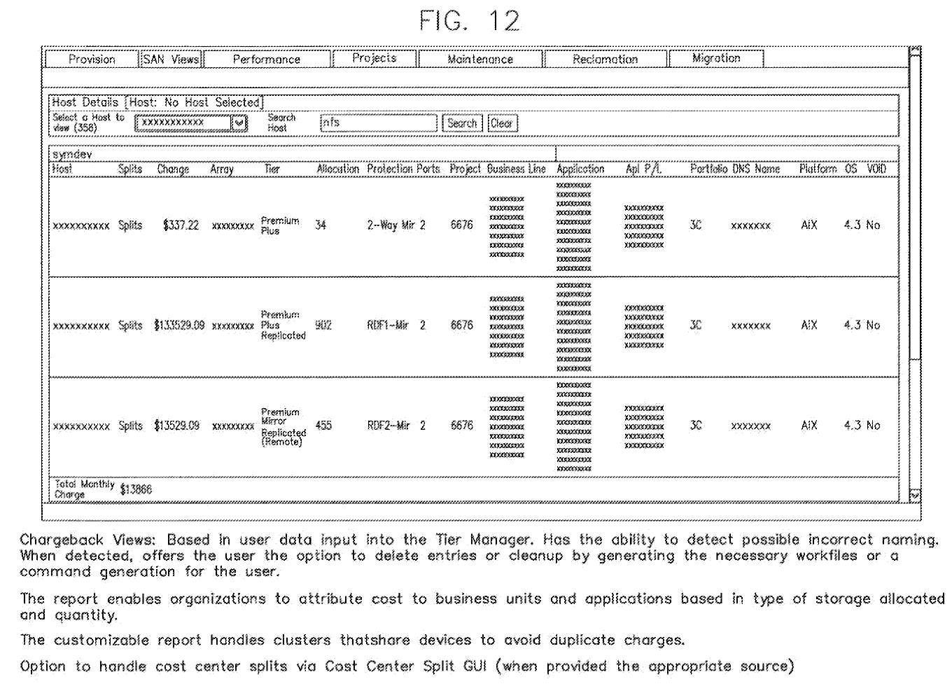

Various screens depicting an embodiment of the invention utilizing a chargeback calculation are presented in FIGS. 11-14. FIG. 11 shows the various tiers present in a storage area network and the cost of utilizing that particular tier. FIG. 11 also shows an edit screen, accessible simply by clicking on one of the tiers listed in the tier management screen, which allows a user to edit the attributes of a particular tier including the cost of utilizing that tier. Once this information has been entered, the information for any particular host will display the tier that particular host utilizes on a chargeback view, as depicted in FIG. 12. Next to the host name is the charge, in dollars, of storage value attributable to that particular host. The business lines for every host are also listed, which may be particular areas of a business such as accounting or marketing depending on the desired implementation.

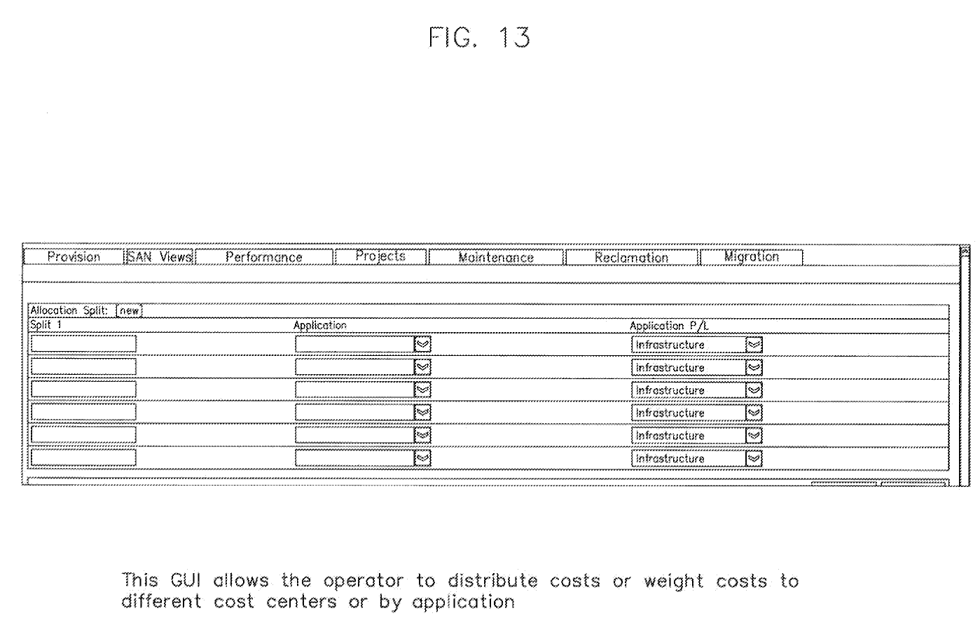

FIG. 13 depicts an interface that allows a user to split the costs of a particular host to more than one particular application used by different business units. In some embodiments, different programs or applications utilize different amounts of storage. If one particular program uses a large amount of storage and that program is only utilized by one business unit, the storage associated with that program should be attributed to that business unit even if the program resides on a host that is also utilized by other business units. The split depicted in FIG. 13 enables an administrator to divide up costs by application, not only by host, so that storage associated with applications can be properly charged back.

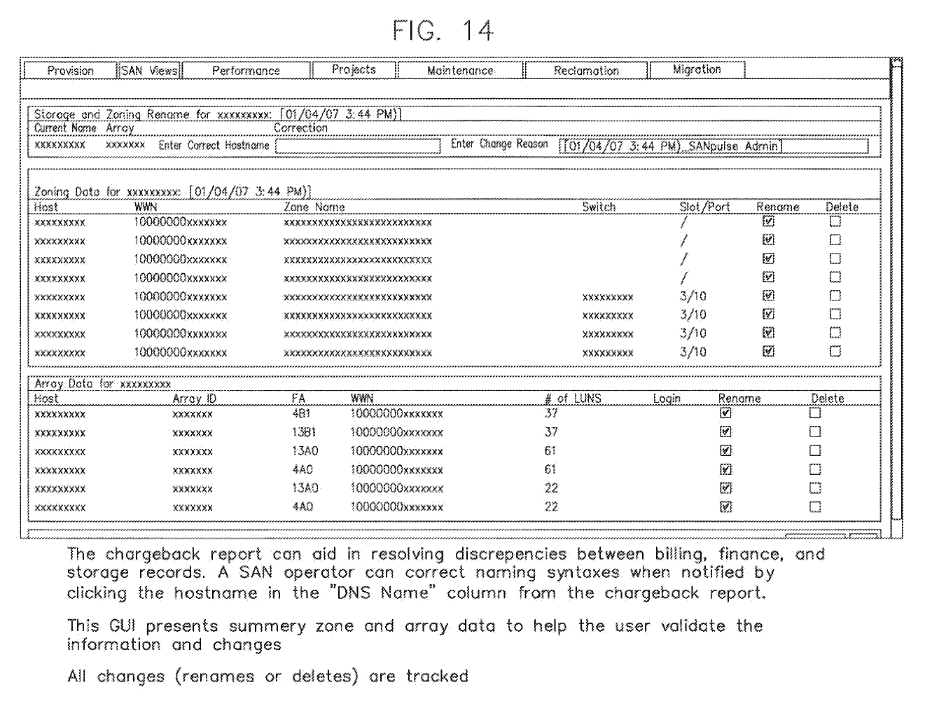

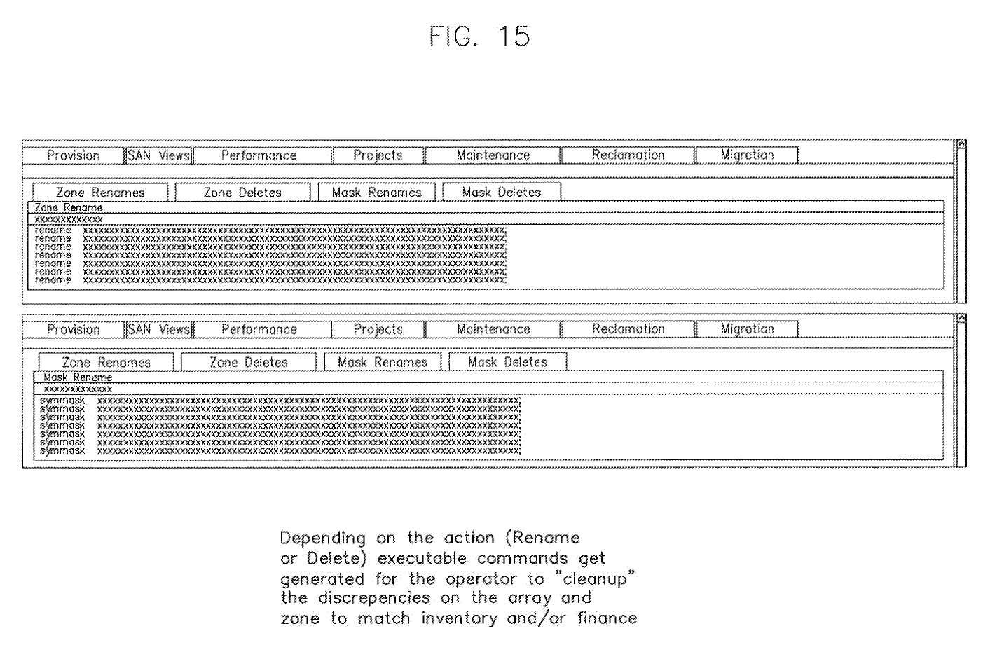

In order to aid in recordkeeping or accounting, a user may wish to change the name of the configuration related to a host. A mechanism for changing the host name is depicted in FIG. 14, where the zone data and array data for a particular host are depicted in order to ensure that the user is renaming the proper host. The system will generate a series of commands to rename the host, which may be viewed by the user as depicted in FIG. 15.

In one embodiment, the user may load information into the database concerning the desired software that should be operational on the various devices across the system. The system may then extract the software running on each of the devices when the configuration data is collected from the SAN. The extracted data may be compared to the data entered by the user in order to produce a list of devices that are not utilizing optimal software as defined by the user. For example, if the user enters information stating that all Model A HBAs on the network should be utilizing an Eagle firmware with a version of 2.0 or greater, the user will be notified of any Model A HBAs that are not operating with that firmware. The user may use this information to upgrade the firmware on HBAs that are not utilizing optimal firmware in order to improve the efficiency of the system. The system may also communicate with hardware or firmware databases through the Internet to determine what versions should be used on any particular hardware device in the SAN.

In one embodiment, the present invention may be utilized to reconfigure storage in order to optimize SAN efficiency. The SAN evaluation software may include programs adapted to inform the user how to optimize the storage in the system. This may include moving certain data to locations which makes the data more easily accessible, deleting meaningless data, or creating new zones which allow hosts to access storage arrays more quickly. The system may also be used to allocate storage, particularly new storage, to hosts based on the current configuration in order to obtain the most efficient SAN possible. For example, the SAN evaluation software may issue a query to a particular storage port in order to all zones that utilize that particular port. If the results show that a particular port is being overutilized, the system may divert traffic away from that port or may simply configure new storage to other ports. Such commands or scripts may be run on the system in real time.

In one embodiment, the SAN evaluation software may be set up to periodically query a SAN, import configuration data from the SAN, organize the data into a database, and generate reports that may be automatically sent to user such as a SAN administrator. The reports may be customized by the user and may include information such as storage assigned to each host or a list of data stored in a storage array that is not attributed to any host. In one embodiment, the SAN evaluation software is periodically run but only generates and sends reports upon the discovery of a problem, such as reclaimable storage or stale LUN entries. In this embodiment, the software becomes not only a SAN evaluation tool but also a SAN monitoring tool.

The SAN evaluation software may be set up to periodically query a SAN, import configuration data from the SAN, organize the data into a database, and save the database. Over time, the saved databases will provide a user with a historical view of the SAN configuration and how it has changed over time. These historical databases may also be useful if the SAN malfunctions to trace the cause of the malfunction to a change in configuration.

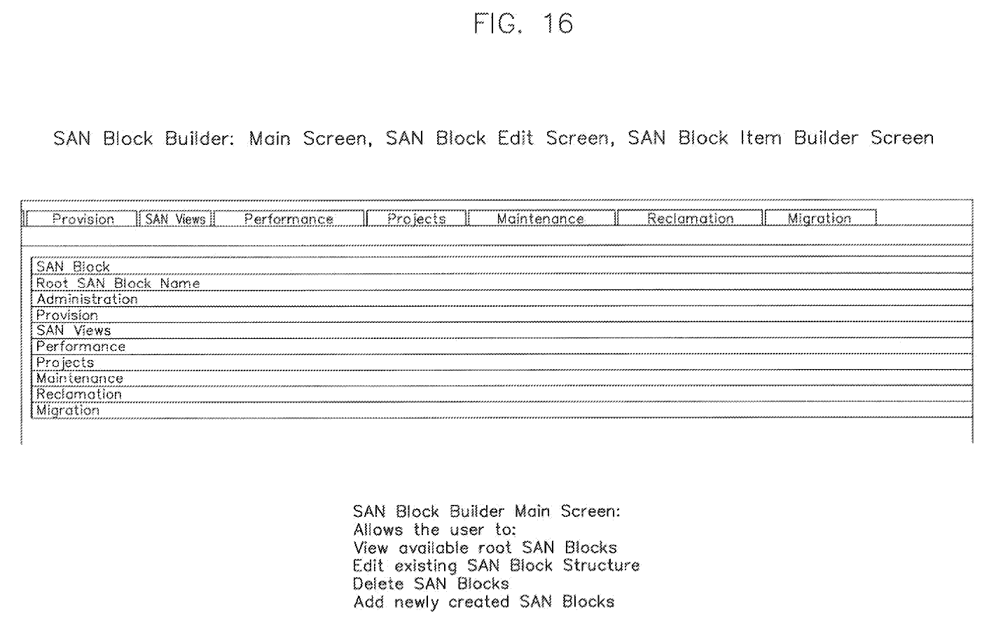

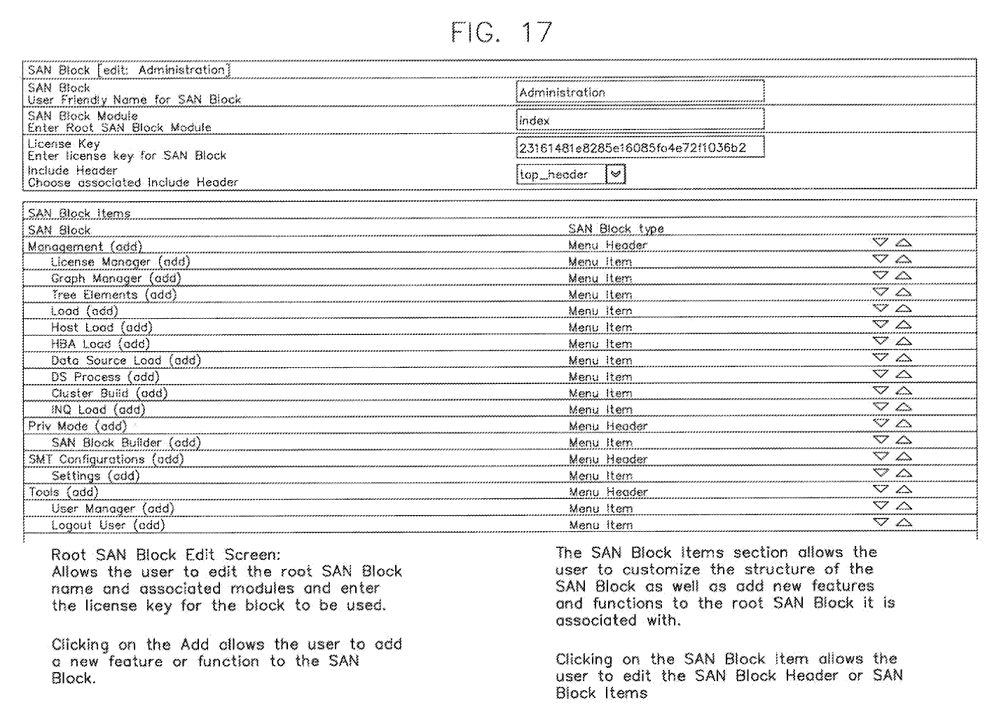

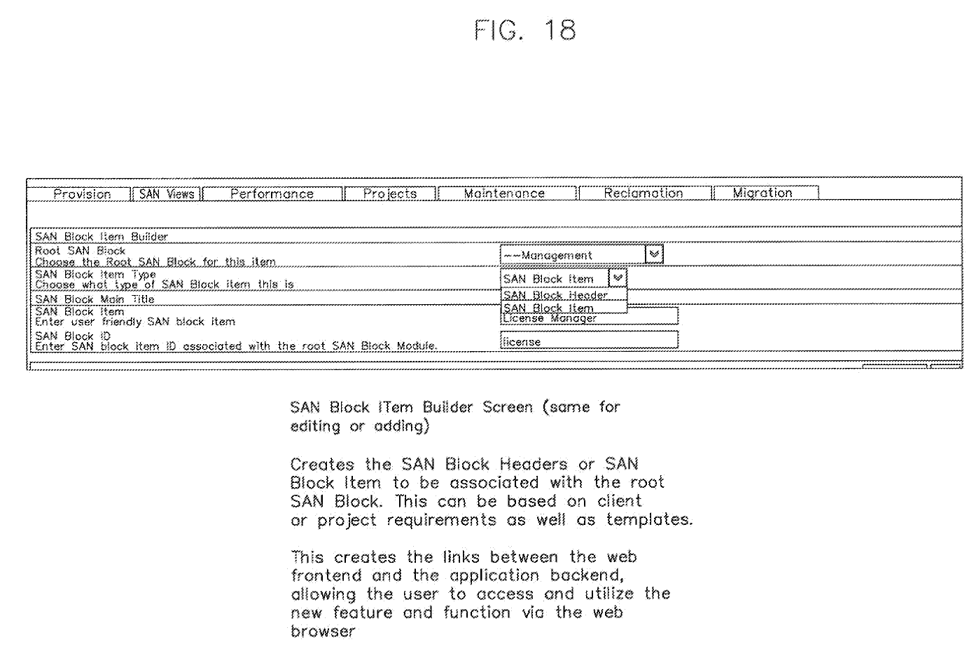

Screenshots from one embodiment of the invention showing an interface for customization are depicted in FIGS. 16-18. In this embodiment, the various tabs at the top of the screen are called “SAN Blocks.” This view shows the various SAN blocks on a menu so that the user may click on one of the SAN blocks in order to modify it. FIG. 17 shows the screen that is presented to a user when the user decides to edit one of the SAN blocks. The screenshot in FIG. 17 also shows the various SAN block items that are available to the user so that the user may edit these as well. In this way, the user may customize the tabs on the top of the screen and the menu items contained therein in order to provide quick links to various steps that the user performs frequently. FIG. 18 depicts the screen a user is presented with in order to build SAN blocks and define where they should reside on the user interface.

In one embodiment, the system may function as an application service provider (ASP). In this embodiment, the system comprises software that may be provided to a user over a network such as the Internet. The user will be able to access the application and all of the views provided by the system over the Internet, in a program such as a browser. In this embodiment, the user may type in a particular address into a browser in order to navigate to the software and may be required to log in with a username and password. The user may then have access to the various views of the database and may even be able to manipulate the configuration of the SAN using the ASP.

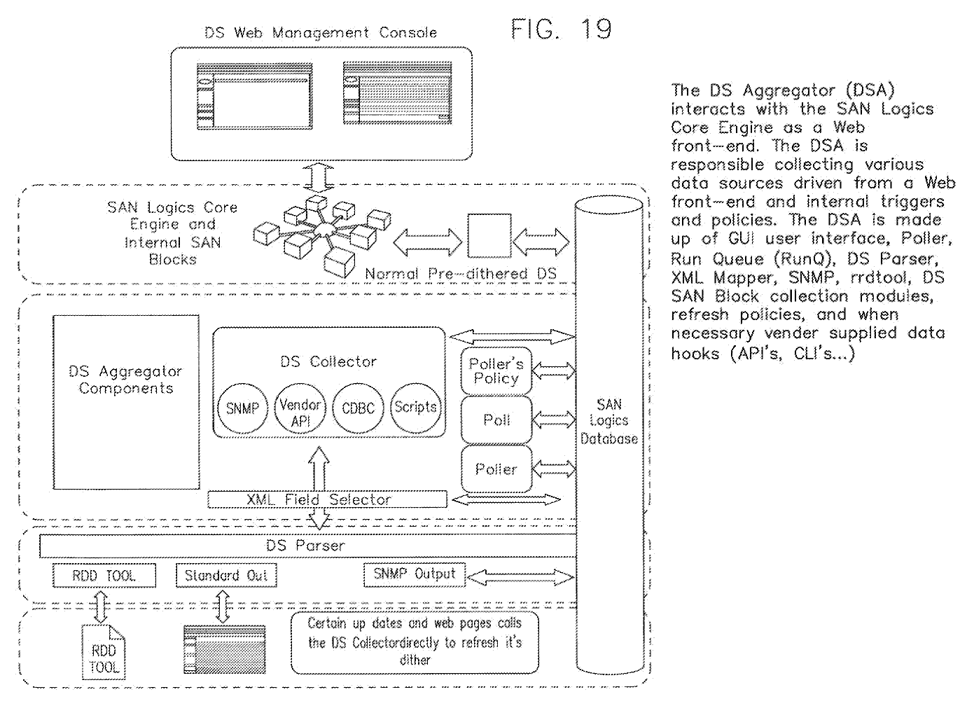

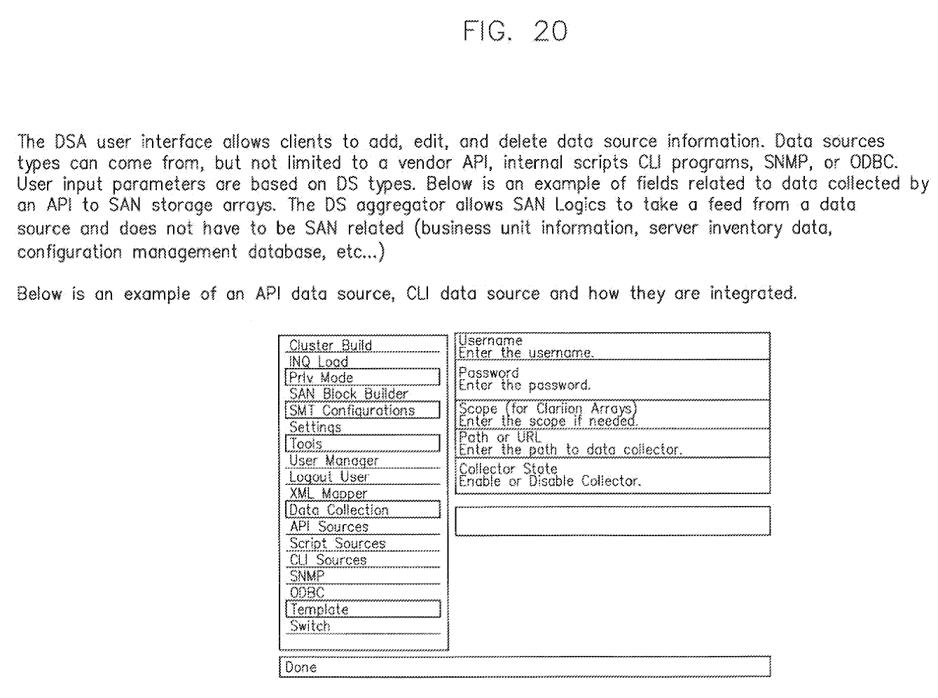

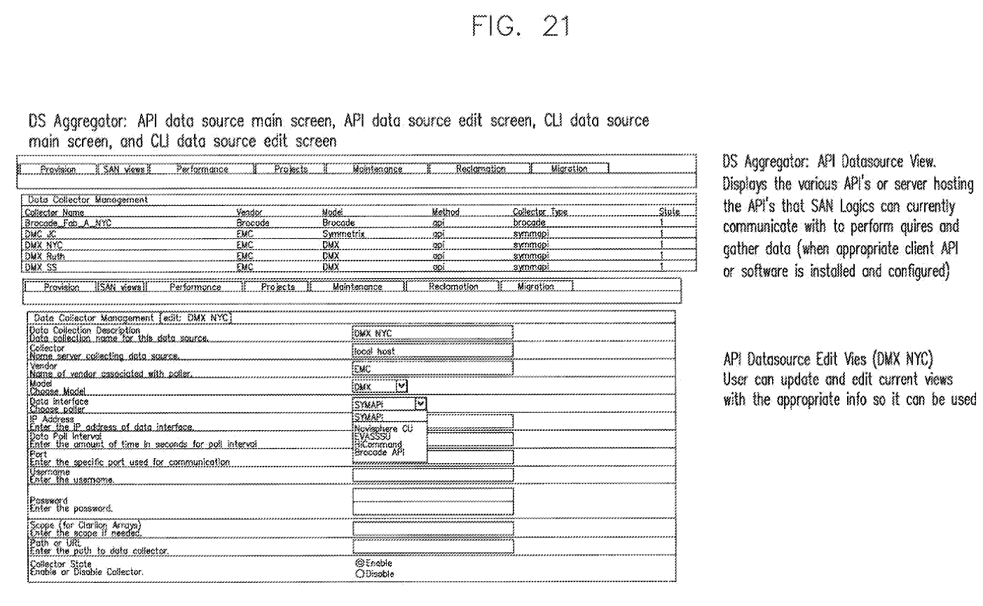

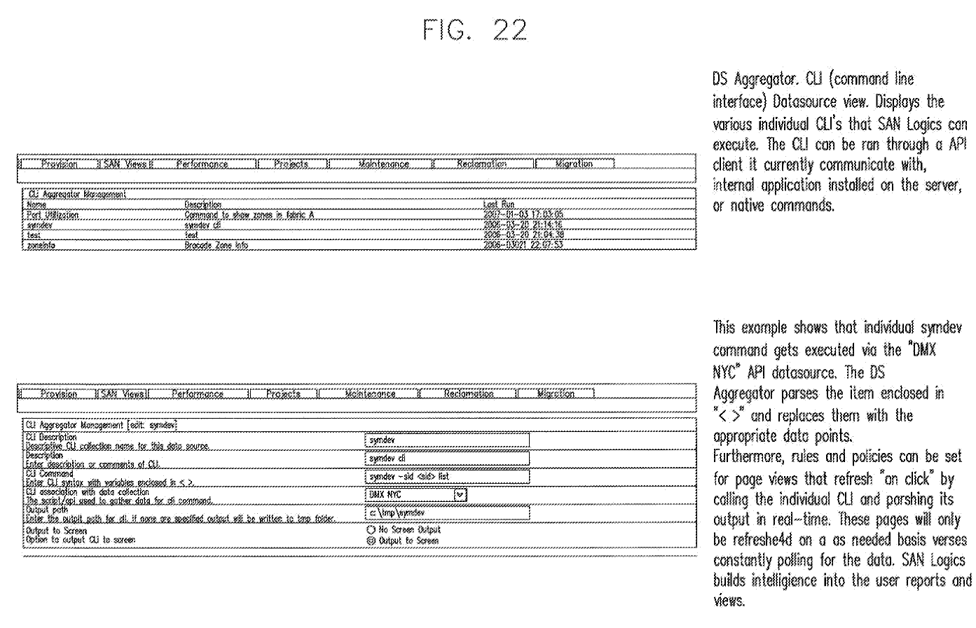

FIG. 19 depicts one embodiment of a data source aggregator (DSA) according to the present invention. The DSA collects configuration data for the system from a plurality of sources. As depicted in FIG. 20, a user may control the various sources of data that are accessed and added to the system by the DSA. The user may add additional sources of data as depicted in FIG. 21 and provide details for each data source. The user may then return to edit the data sources or particular information concerning the data sources as depicted in FIG. 22.

It will be apparent to one skilled in the art that various modifications and variations on the invention are possible without departing from the scope of the invention as set forth in the appended claims.

I claim:

1. A method for examining the configuration of a storage area network using a browser application, comprising:
linking to a portion of the storage area network using the browser application wherein the browser application links to the portion of the storage area network at least one of directly or through a switch;
obtaining data from one or mote devices comprising a portion of the storage area network that defines one or more parameters about the one or more devices;
parsing the data from each of the one or more devices into one or more records;
eliminating redundancies in the one or more records;
adding the one or more records into a database-in a predetermined format; and
providing a user access to the records in the database through a first graphical user interface generated by the browser application wherein the first graphical user interface provides for linking to a second graphical user interface that provides access to the one or more records from the one or more devices.

2. The method of claim 1 wherein the one or more parameters includes a worldwide name.

3. The method of claim 1 wherein the one or more parameters includes a logical unit number.

4. The method of claim 1 wherein the one or more devices comprises one or more hosts.

5. The method of claim 1 wherein the one or more devices comprises one or more storage arrays.

6. The method of claim 4 wherein the one or more records for the one or more hosts comprises data identifying each host bus adapter coupled to the host.

7. The method of claim 6 wherein the one or more records for the one or more hosts further comprises data identifying one or more zones used by the host.

8. The method of claim 7 wherein the data identifying one or more zones used by the one or more hosts indicates which storage arrays are accessed by a host.

9. The method of claim 8 wherein the record for the one or more hosts comprises data identifying the amount of storage space allocated to the one or more hosts on one or more storage arrays accessed by the one or more hosts.

10. The method of claim 9 wherein the record for the one or more hosts comprises data identifying one or more switches utilized by the one or more zones.

11. The method of claim 1 further comprising allowing a user to manually add data to the database.

12. The method of claim 1, further comprising allowing the user to search the database for a particular device connected to the storage area network using a search engine.

13. The method of claim 12 wherein the search engine is a boolean search engine.

14. The method of claim 1 wherein relationships between the one or more devices are depicted on the graphical user interface.

15. The method of claim 1 further comprising searching for configuration errors in the storage area network.

16. The method of claim 15 wherein the user is notified on the graphical user interface if any configuration errors are found.

17. A method for evaluating the configuration of a storage area network comprising:
coupling a browser application to the storage area network;
executing one or more commands on the storage area network to obtain device information for one or more devices comprising the storage area network;
parsing the device information into one or more device records;
eliminating redundancies in the one or more device records;
storing the one or more device records in a database;
providing access to a user to the database through a first graphical user interface generated by the browser application wherein the first graphical user interface provides for linking to a second graphical user interface that provides access to the one or more device records.

18. The method of claim 17 wherein the first graphical user interface is viewable in a first portion of a display and a second graphical user interface is viewable in a second portion of the display.

19. The method of claim 17 wherein the browser application is a web browser.

20. The method of claim 17 wherein the browser application is coupled to the storage area network through a control workstation.

21. The method of claim 17 wherein the one or more commands comprise system commands.

22. The method of claim 17 wherein the device information comprises a worldwide name.

23. The method of claim 17 wherein the user is presented with all device information for a particular device when the user selects the link corresponding to a particular device.

24. The method of claim 21 wherein the user is presented with all device information for one or more devices coupled to the particular device when the user selects the link corresponding to the particular device.

25. The method of claim 17 wherein relationships between one or more device records are depicted on the graphical user interface.

26. A software storage medium including a software program which, when executed by a processing arrangement, is configured to examine a storage area network, said software program comprising:
a first module which, when executed, links to a portion of the storage area network using a browser application wherein the browser application links to the portion of the storage area network at least one of directly or through a switch;
a second module which, when executed, obtains data from one or more devices comprising the portion of the storage-area network that defines one or more parameters about the one or more devices;
a third module which, when executed, parses the data from each of the one or more devices into one or more records;
a fourth module which, when executed, eliminates redundancies in the one or more records;
a fifth module which, when executed, adds the one or more records into a database in a predetermined format; and
a sixth module which, when executed, provides access to the database to a user through a first graphical user interface generated by the browser application wherein the first graphical user interface provides for linking to a second graphical user interface that provides access to one or more records from one or more devices.
